(19) United States
(12) Patent Application Publication
(10) Pub. No.: US 2017/0200382 A1
(43) Pub. Date: Jul. 13, 2017

(54) NDT File Cabinet

(71) Applicant: David A. Mandina, Belle Chasse, LA (US)

(72) Inventor: David A. Mandina, Belle Chasse, LA (US)

(21) Appl. No.: 15/469,833

(22) Filed: Mar. 27, 2017

Related U.S. Application Data
(63) Continuation of application No. 14/555,331, filed on Nov. 26, 2014.
Application No. 14/555,331 is a continuation-in-part of application No. 14/492,613, filed on Sep. 22, 2014, now abandoned.
(60) Provisional application No. 61/880,282, filed on Sep. 20, 2013.

(51) Int. Cl. G09B 5/08; G09B 5/10; G09B 7/00; G06Q 10/06; G06Q 50/04; G09B 5/06; G09B 5/12

(52) U.S. Cl. CPC G09B 5/08; G09B 5/06; G09B 5/10; G09B 5/12; G06Q 10/06398; G06Q 10/063112; G06Q 50/04; G09B 5/065; G09B 7/00

(57) ABSTRACT

A global information training and tracking system is provided for training of employees, clients or trainees. The system may include a data management system accessible remotely. The system may include various modules for training of specific skills and may include testing. The system may be configured to compile testing/evaluation information regarding the training and individuals being trained.

### FIELD

The present invention relates generally to systems and methods for training and tracking, and in a particular though non-limiting embodiment, to a software package disposed in communication with a processing device that admits to variable and selectable user interaction across platforms and user environments and admits to the sharing of training across a plurality of members of a defined user group.

### BACKGROUND

Companies devote substantial time, resources, and effort into skill development and training of employees, and expenditures on corporate training are rising. Current estimates for United States companies' approximate spending annually on corporate training and learning are between $70 Billion and $150 Billion. Certain estimates have worldwide expenditures on corporate training nearly double that of the U.S.

Training by companies is generally used to fill skill/knowledge gaps in existing employees or available workforce. Traditionally, training and/or corporate education has occurred in classrooms or similar in person facilities. Some companies have incorporated certain virtual training approaches to reduce overall costs, yet training in each of the various formats often fails to provide lasting educational changes in the employees and/or trainees.

In addition to high costs associated with training programs, most training programs do not effectively evaluate the success of training or ability of the trainees after a program. Objectives are not usually clear and precise, and little feedback is provided to trainees to ensure the skills are absorbed and repeatable. Testing is also usually overlooked or not sufficiently tailored to allow for accurate measurements of success.

Accordingly, there is need for a training program that allows for remote, virtual training around the world and performance evaluation allowing for sufficient tracking of trainees training in the program.

### SUMMARY

In an embodiment of the present invention, a system for training is provided, including: a database; a plurality of modules; and software disposed in communication with a processing device. The plurality of modules include training programs for a plurality of skills and testing programs for the plurality of skills. The database is accessible remotely. The plurality of modules are customizable. The system may include means for variably and selectably allowing user interactions across platforms and user environments, and means for sharing training across a plurality of members selected from a predefined user group. The plurality of modules may include ultrasonic thickness, ultrasonic levels, ultrasonic phased array, ultrasonic ToFD, liquid penetrant levels, magnetic particle levels, radiation safety, radiography levels and visual testing levels. The system may be configured to test a trainee on a skill be trained. The system may be configured to archive test results of trainees. The system may enable data transfer between remote locations.

### DESCRIPTION

Embodiments of the present invention provide a system for training employees/trainees and for tracking and evaluating the training. Embodiments of the present invention provide a global information system having data management accessible worldwide. The data management system may be accessible on a variety of platforms. The training system may provide for uniform training throughout the globe and testing and certification programs for evaluation of the training. The system may enable information sharing within organizations, manufacturers and societies worldwide.

Embodiments of the present invention provide a system that trains, tests, and tracks trainees and provides notifications to administrators regarding certifications and potential equipment collaborations. The system may provide for document management of training throughout an organization with global access to any size file at any time. Embodiments of the present invention allow for more effective and cost efficient training and tracking of workers.

Embodiments of the present invention may include a variety of exams, such as eye exams. The system may include numerous modules for training, which modules may be tailored to the skills to be taught. Modules may include, as examples only, ultrasonic thickness, ultrasonic levels, ultrasonic phased array, ultrasonic ToFD, liquid penetrant levels, magnetic particle levels, radiation safety, radiography levels and visual testing levels. The system may be configured to track times a trainee is engaged with the system and/or a particular module. The system may be configured to consolidate records for individual trainees, including certifications, testing and completion.

Embodiments of the present invention may include testing for personnel or other trainees using a database that randomizes questions and answers such that no tests are the same. The database may incorporate images, sketches, charts and graphs. The system may include pre-designed examinations or tailored examinations based on needs of an organization. Examinations may be assigned and automatically scored. The system may archive tests and trainee results, which may allow for trainee evaluations by an organization.

Embodiments of the present invention provide for more individualized training of a trainee using customizable features. The system may be configured to provide training for specific instruments and/or specific methods. The training and tracking information may be constantly updated and accessible remotely. Embodiments of the present invention substantially reduce costs over traditional training programs.

In a presently contemplated commercial embodiment, said system is primarily applicable for training and tracking within the inspection industry. As those of ordinary skill in the pertinent arts will readily appreciate, however, the system and attendant software package may be modified to accommodate training and tracking development in virtually any industry.

In one example embodiment, an appropriately developed software package is coded using one or more species of open source code. In another example embodiment, the software comprises means for interfacing program features and users using a cloud based data storage and distribution system.

Within the context of this application, the phrase “means for” carrying out various functionalities associated with a system of the present invention comprises a software program or a software package programmed so as to enable various software-related means such as machine code, source code, object code, code operators and indicators and the like to act directly or indirectly, with or without the temporal assistance of related hardware or firmware, in order to carry out at least the functionality specified herein, regardless of whether such functionality or means therefor are presently known or future devised, so long as said functionality and means therefor reside within the general understanding of one of ordinary skill in the art.

In one example embodiment, the system admits to program participation by one or more users working for separate, different and/or geographically remote business entities; in those instances the software package further comprises means for distinguishing between respective user identities and isolating program presentation in accord therewith so that users of the system contemporaneously receive only data and information relevant to that specific user origination entity.

In another embodiment the package is not platform dependent, and functions as desired across a broad range of recognized platforms, e.g., Flash, Power Point, Captivate, etc. The system can therefore be packaged and sold to either individual or multiple business entities with equal resulting efficacy.

In other embodiments, members of the various user groups share a training environment with other members of the user group. In still other embodiments, the system archives some or all associated testing information in real-time and/or admits to amendment or alteration of the test question database without affecting any of the previously archived data. In still other embodiments the system tracks the times and dates of user activities and/or archives such information for subsequent correlation or review.

In one specific though non-limiting embodiment the system comprises a data management system that can be accessed anywhere in the world; which works across multiple platforms; and is developed to address uniform training, testing and certification program needs within virtually any organization or industry.

In another detailed exemplary embodiment, the system enables information sharing within organizations, manufacturers and societies worldwide; trains, tests, tracks and notifies system administrators of related personnel certifications and equipment calibrations; and facilitates comprehensive organization and management of all documentation associated with a subject organization.

In one embodiment, a training system comprises a plurality of online modules to train personnel and/or clients, which are customizable to meet the individual and code requirements of your company; tracks identity of participants and their engaged in online training; and automatically generates, consolidates and/or archives personnel certification documents from a database upon completion.

In other embodiments, the system improves the user learning experience by means of one or more of a plurality of interactive applications, for example, animated and/or interactive slides; movies or other audiovisual presentations incorporating specifically applicable methods and equipment; intermittent quizzes that ensure graduated familiarity with prescribed subject matter, etc.

In further embodiments, a testing module admits to testing of desired personnel and clients using one or more of a plurality of state-of-the-art pedagogical peripherals, such as an electronic database; randomized question & answer presentations; creation of new tests and/or repetition of desired core subject matter until satisfactory performance is achieved; employment of electronic images, sketches, charts and graphs, and so on. Relying on pre-designed examinations or custom-developed tests based on the predefined needs of a specific client, examinations can be assigned and automatically scored, and a certificate indicating satisfactory progress or completion can be generated. In one specific embodiment, tests and their scored results are archived in each user's profile for subsequent evaluation.

In still further embodiments, a document control module enables easy-to-navigate control over all related documentation, which can be generated, correlated, stored, accessed, organized, reviewed and managed by designated personnel subject to a hierarchal arrangement of associated passwords and permissions.

For example, transfer inspection reports filed from one location can be transferred to another for training, auditing or evaluating purposes, with support for any data format or document size, and or all of which can be viewed, stored, archived, deleted, etc., either locally or remotely, thereby achieving fully integrated document processing from virtually anywhere in the world.

The foregoing specification is provided for illustrative purposes only, and is not intended to describe all possible aspects of the present invention. Moreover, while the invention has been shown and described in detail with respect to several exemplary embodiments, those of ordinary skill in the pertinent arts will appreciate that changes to the description, and various other modifications, omissions and additions may also be made without departing from either the spirit or scope thereof.

What is claimed is:

1. A system for training, comprising:
a database;
a plurality of modules; and
software is disposed in communication with a processing device;
wherein the plurality of modules include training programs for a plurality of skills and testing programs for the plurality of skills;
wherein the database is accessible remotely; and
wherein the plurality of modules are customizable.

2. The system of claim 1, further comprising:
means for variably and selectably allowing user interactions across platforms and user environments, and
means for sharing training across a plurality of members selected from a predefined user group.

3. The system of claim 1, wherein the plurality of modules include ultrasonic thickness, ultrasonic levels, ultrasonic phased array, ultrasonic ToFD, liquid penetrant levels, magnetic particle levels, radiation safety, radiography levels and visual testing levels.

4. The system of claim 1, wherein the system is configured to test a trainee on a skill be trained.

5. The system of claim 4, wherein the system is further configured to archive test results of trainees.

6. The system of claim 1, wherein the system enables data transfer between remote locations.
